(19) United States
(12) Patent Application Publication
(10) Pub. No.: US 2002/0159770 A1
(43) Pub. Date: Oct. 31, 2002

(54) Game camera

(76) Inventor: Ferrell C. Moultrie JR., Roswell, GA (US)

Correspondence Address: Wm Bruce Day, Swanson Midgley LLC, 2420 Pershing Road Suite 400, Kansas City, MO, 64108, US

(21) Appl. No.: 09/845,641

(22) Filed: Apr. 30, 2001

(51) Int. Cl. G03B 17/00

(52) U.S. Cl. 396/265; 396/427

(57) ABSTRACT

A surveillance camera for wild game animals includes a camera having automatic flash, focus, aperture and shutter speed and film advance functions. The camera is mounted within a housing adapted for outdoor installation and protection from adverse weather conditions. An electronic control circuit mounted within the housing is operably connected to the camera and includes a programmable microprocessor providing an interval set function for timing between taking photographs. The camera is activated by a passive infrared sensor detecting body heat of the animal or group of animals to be photographed. Day/night enable and aiming light functions are provided. The electronic control circuit is designed for extremely low voltage requirements.

### FIELD OF THE INVENTION

This invention relates to surveillance cameras and particularly to self-operating cameras which are battery operated and used for taking still photographs of game animals and other wildlife.

### BACKGROUND OF THE INVENTION

Surveillance cameras for photographing game animals and other wildlife have become popular as the technology of such cameras has improved. These advanced cameras utilize a relatively inexpensive fully automatic camera which provides automatic focus, flash, aperture and shutter speed and film advance functions. Such cameras are mounted along trails, salt licks, feeders and in other areas known to be frequented by game animals and other wildlife. By using these cameras, wildlife agencies may identify species within the area of study and determine the density and health of the population. Wildlife agencies are not the only purchasers of game cameras and they are also popular with sportsmen hunters who use game cameras to identify trophy animals within the study area. Especially popular with deer hunters, a hunter may use several game cameras to determine the location and routines of large bucks. The surveillance camera is mounted along a trail or watering hole and is left for several days or several weeks until the person returns and unloads the film for processing.

These cameras are designed to take a photograph upon sensing an animal within a preselected target area. Sensors for some cameras include photoelectric eyes which sense an interruption in a lightbeam between emitters and reflectors. Other types of sensors used are infrared sensors which sense the body heat of an animal. The sensitivity of an infrared receiver may be selected so as to trigger the game camera shutter release only upon receiving an IR intensity above a given threshold, such as a level associated with a large game animal such as a trophy deer instead of the local skunk passing through. Moreover, the game camera is left out in the field during daylight and nighttime conditions and necessitates day/night enable capabilities.

The environment of use of a game camera is hostile. Winter temperatures during operation may be as low as 0° F., particularly for the period shortly before dawn when many animals are most active. Summer temperatures within the game camera housing may approach 150° F. when in direct sunlight in southern climes. Temperature variations between these extremes requires stable operation over a wide range of temperatures for control electronics within the game camera. Preferably, the game camera must be capable of continuous operation for multi-day and multi-week periods from readily available battery power sources. For example, the inventor has determined that a 6 volt dc battery is an ideal, inexpensive and readily available power source, but to last for several weeks of continuous operation, the powered device must consume no more than small amounts of power such as 20 to 50 microamperes. The electronics of the game camera must be reasonably tolerant of power supply sag as the battery approaches its discharge limits. These requirements tend to require electronic devices with a very stable operation with low power requirements. The inventor has determined that a game camera is preferably controlled by a microprocessor unit specially designed for extremely low power consumption.

### SUMMARY OF THE INVENTION

A surveillance camera particularly for game and wildlife comprises a camera having automatic flash, focus, aperture and shutter speed and film advance functions. The camera is mounted within a housing adapted for outdoor installation and protection from adverse weather conditions including intense sun, cold and precipitation. An electronic camera control circuit is mounted within the housing and connected to the camera. The control circuit is designed for extremely low power consumption and includes a programmable microprocessor allowing users to control some of the functions of the camera.

### OBJECTS OF THE INVENTION

The objects of the present invention are:

to provide a game camera having photograph taking intervals settable by a camera user;

to provide such a game camera which is resistant to climatic extremes;

to provide such a game camera using an electronic control circuit with extremely low power consumption requirements; and

to provide such a game camera which is economic to produce, reliable and long-lasting in operation and particularly well adapted to the intended purpose.

### BRIEF DESCRIPTION OF THE DRAWINGS

FIG. 1 is a plan view of a game camera embodying the present invention.

FIG. 2 is a frontal elevational view of the game camera shown in FIG. 1.

FIG. 3 is a side elevational view of the game camera shown in FIG. 1.

FIG. 4 is a bottom view of the game camera.

FIG. 5 is a plan view of the game camera with housing lid removed to show internal components.

FIG. 6 is an enlarged view of the control panel of the game camera.

FIG. 7 is a block diagram showing the functions of the electronic circuit of the game camera.

FIG. 8 is an electrical schematic of the electronic circuit.

FIG. 9 is a flow diagram of an initialize software algorithm in the processor of the electronic circuit.

FIG. 10 is a flow diagram of a take picture software algorithm within the processor of the game camera circuit.

FIG. 11 is a flow diagram of a wait for target software algorithm within the processor.

FIG. 12 is a flow diagram of a timing software algorithm within the processor of the electronic circuit.

### DESCRIPTION OF THE PREFERRED EMBODIMENT

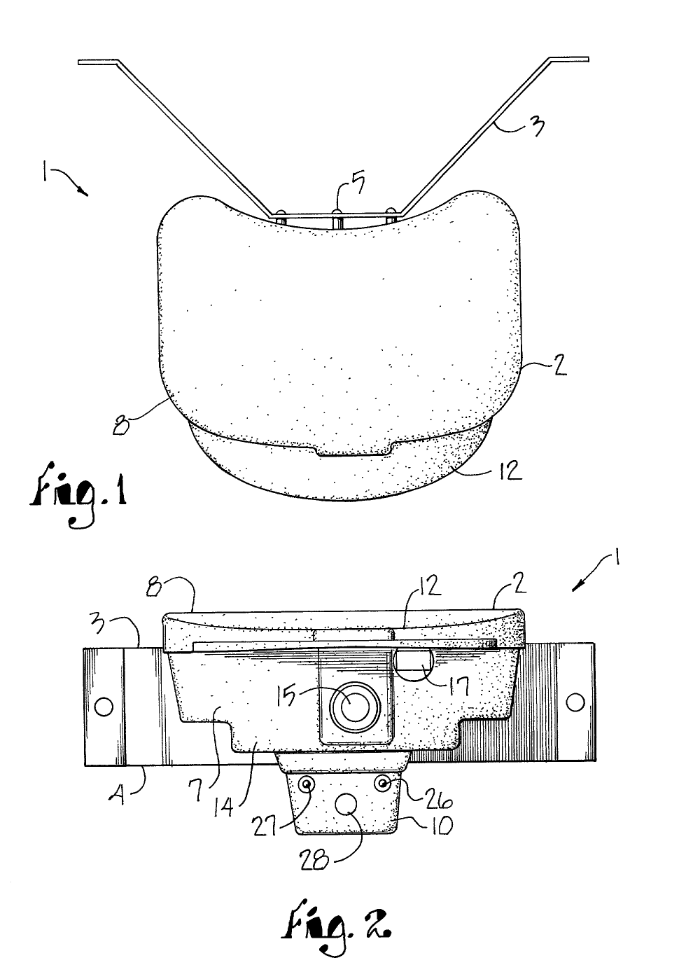

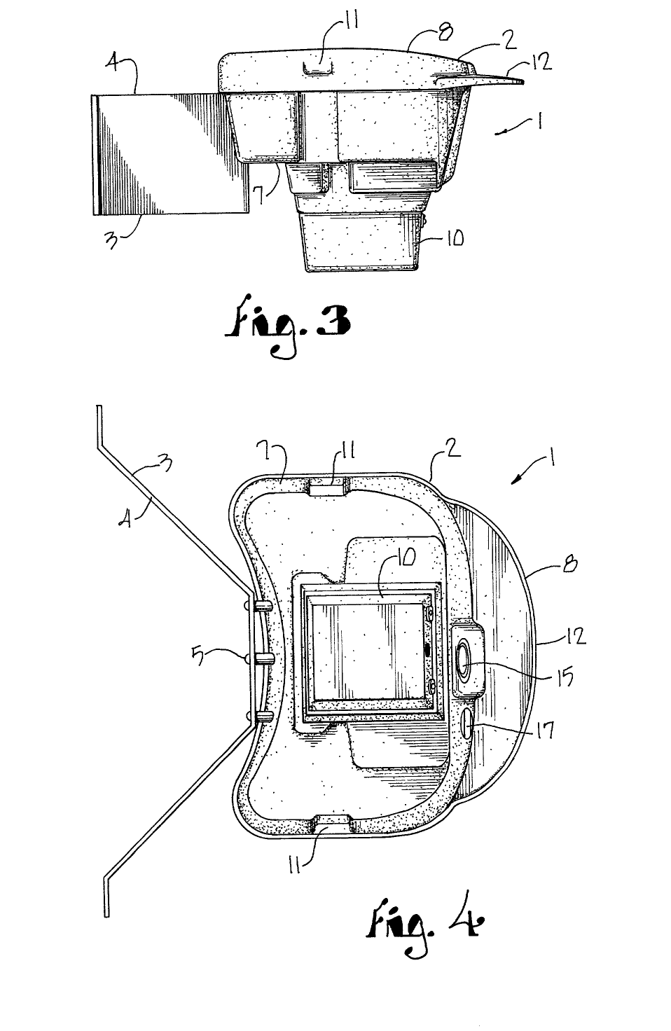

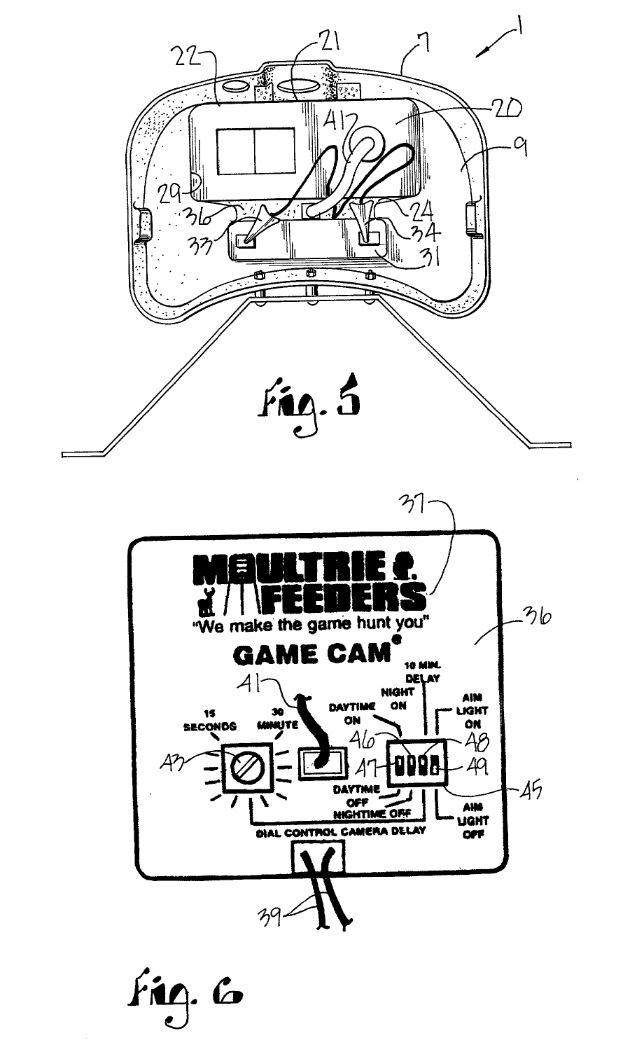

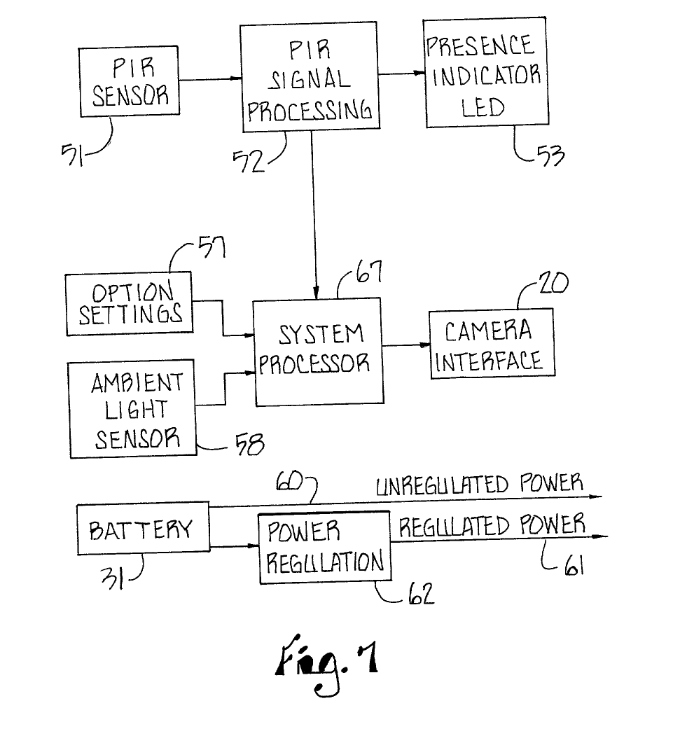

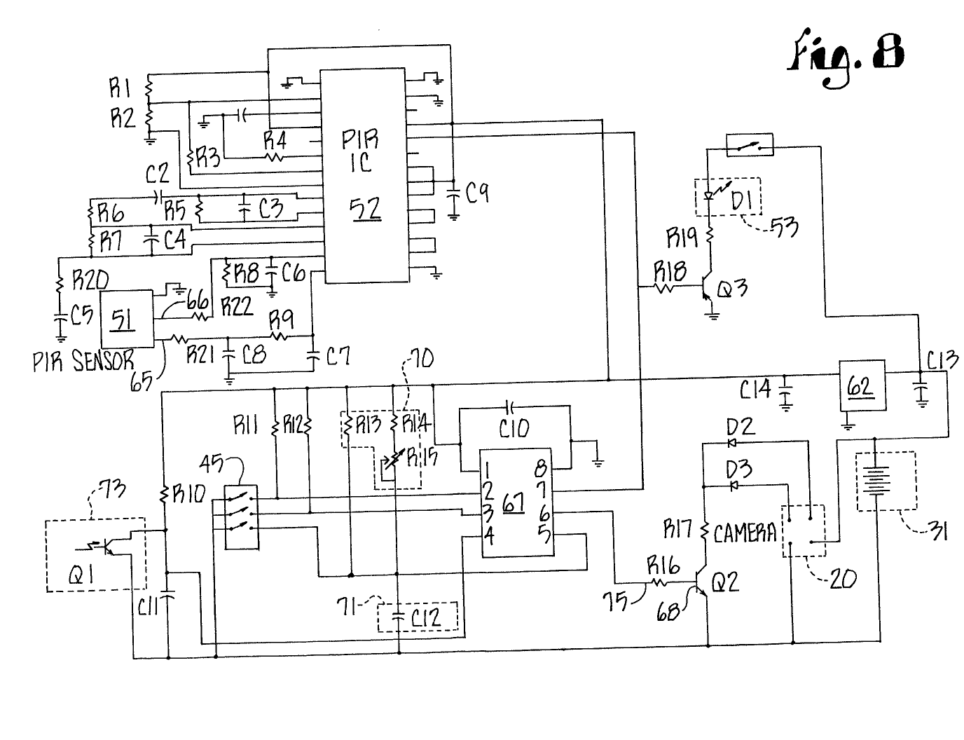

The reference number 1, FIGS. 1-4, generally indicates a game camera embodying the present invention. The game camera 1 consists of a housing 2 containing elements as hereinafter disclosed and a mounting bracket 3 attached to the back of the housing 2. The game camera 1 is constructed for placement along a game trail or other place where game animals or other wildlife are likely to pass. The housing 2 is designed and constructed to be impervious to the adverse summer and winter weather conditions normally encountered in continental U.S. conditions. The mounting bracket 3 consists of an angled metal strap with oppositely extending wings 4 for attachment to a support structure, as by bolting to a tree. The metal wings 4 can be bent to accommodate connection to a smaller diameter tree, post or the like. The mounting bracket 3 is attached to the rear of the housing 2 by bolts 5 with spacers. The housing 2 is preferably of an impact resistant plastic and has a main body 7 with a removable lid 8. The main body 7 has an inner well 9, FIG. 5, to receive the inner components and an electronics well 10 located at the bottom of body 7. The removable lid 8 fits snugly against the body 7 by snaps 11 at opposite sides of the housing 2. A visor 12 extends outwardly from the lid 8 and protects the front of the main body 7 from the elements.

The front side 14 of the main body 7 includes a lens hole 15 and a flash hole 17, behind which a camera 20, FIG. 5, is positioned. The camera 20 includes a camera lens 21 and a camera flash aperture aligned with the lens hole 15 and the flash hole 17. The camera 20 is preferably a 35-millimeter camera controlled by a CPU and is fully automatic, providing an auto-focus system, an electronic shutter with multiple exposure capability and slow shutter, a built-in flash, a viewfinder, an automatic film advance and rewinding mechanism. The camera uses two 1.5 volt AA batteries and provides a date imprint on the film. A suitable camera is a Charman AF 9000D remote auto-focus camera.

The game camera 1 includes an electronics package 24, FIG. 5, which cooperates with the camera 1 to enable the user to take pictures during daylight only, nighttime only, or day or night. The camera can also be set to have a delay between each picture taken. The camera provides a minimum delay of fifteen seconds and a maximum of thirty minutes. The delay is adjustable and designed to help conserve film usage in the camera. For example, if the camera was set up on a feeder, the user would probably want a three to five minute delay. In a low activity area, such as a scrape line or trail, a fifteen second delay is useful. For extended filming, the thirty minute delay is useful to take one picture per activity. However, the camera could monitor a particular area for several weeks using the thirty minute delay feature. The front side 14 of the main body 7 includes an aperture 26 for an aim light, an aperture 27 for a day light detector and an aperture 28 for an infrared detector.

Referring to FIG. 5, the camera 20 is positioned within a camera well 29 and adjacent a battery 31. The battery is preferably a six volt 1.3 AH battery in size 613 with its terminals connected to leads into the electronic package 24 via alligator clips 33 and 34. The electronics are covered by a face plate 36 including a manufacturer's name 37 with inbound leads 39 from the battery 31. A camera flash lead 41 extends out from the face plate 36 to connect to a flash input on the body of the camera 20. Referring to FIG. 6, several controls are apparent. Photo interval is set by a potentiometer 43 and ranges between 15 seconds and 30 minutes. A switch array 45 provides options of settings for operation of the camera during daylight only, night-time only, or day and night. Switch One 46 sets the daytime mode for “On or Off.” Switch Two 47 sets the night-time mode “On or Off.” Switch Three 48 in the up position provides a preset ten minute delay between taking photographs. In the down position, Switch Three permits the user to set the delay time using the photo interval dial potentiometer 43. The potentiometer dial 43 is graduated from fifteen seconds to a thirty minute delay between photos. Switch Four 49 turns off or on an aiming light, which is emitted through housing aperture 26. The aiming light is simply a beam of light directed through the aperture 26 so that the picture-taking direction of the game camera 1 can be adjusted to photograph the area selected by the user.

The photo interval delay set by using the photo interval potentiometer 43 is adjustable between a minimum delay of fifteen seconds and a maximum of thirty minutes. The delay is designed to help conserve film usage in the camera 20.

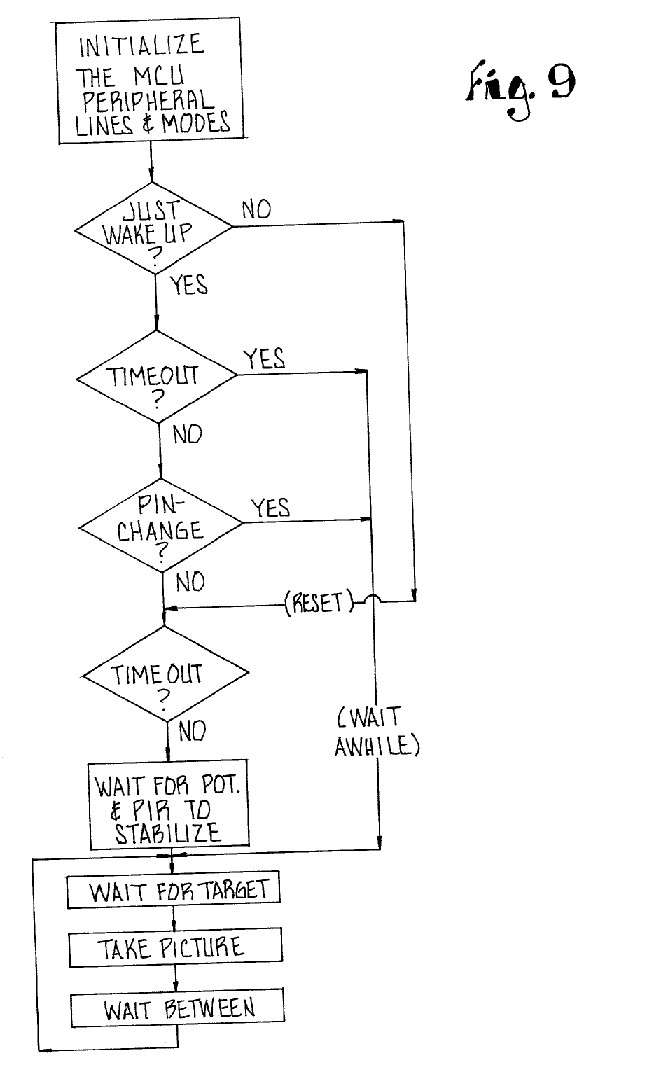

The general layout of the electronics package 24 is shown in connection with FIG. 7. This controller package is of a small physical size in order to minimize undesirable parasitic electrical effects with the low noise passive infrared (PIR) differential signal processing. As shown in FIG. 7, a passive infrared sensor 51 signals a PIR signal processor 52 which in turn lights a presence indicator LED 53. The PIR signal processor 52 provides a presence impulse to the main system processor 67, which is in turn acted upon by the option settings 57 located in the switch array 45 and including switches one, two, three and four identified by numerals 46 through 49. The ambient light sensor, otherwise known as the daylight detector 58, operates as a light meter having an eye located behind the aperture 27 and provides an input signal to the system processor 67. The processor 67 then provides appropriate inputs to the automatic camera circuitry within the camera 20. Also shown in FIG. 7 is the DC battery 31 which provides an unregulated power lead 60 and a regulated power lead 61 through a power regulator/modulator 62.

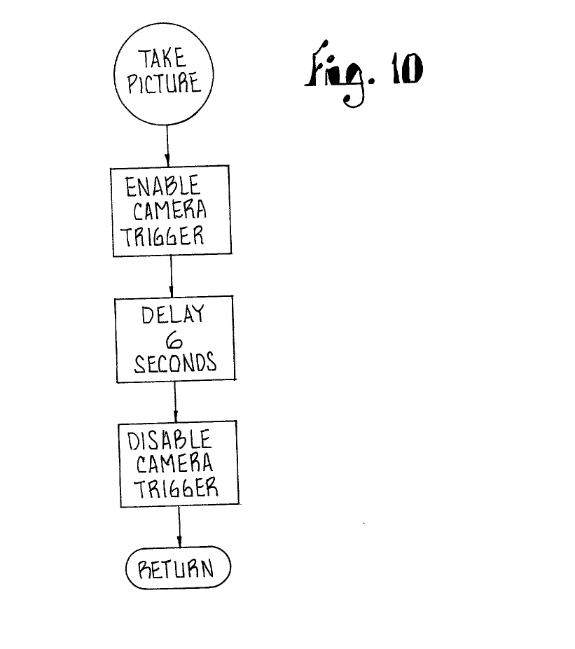

An electrical circuit diagram is shown in FIG. 8. This circuit is designed around the system processor 67 which preferably is an 8-bit, 8-pin CMOS micro controller selected from the PIC 12C50X family of microprocessors. This micro controller can be configured to meet all requirements of the game camera 1 and is of a single package design requiring no external support components. This provides significant improvements in circuit board layout, packaging and is of a reasonable cost. The selected micro controller has significant benefits over a design using either discrete components or general purpose (CISC) microprocessors. The selected micro controller 67 includes six pins dedicated to providing a variety of programmable inputs and output of various types. It uses a unique Schmitt trigger input which is dynamically programmable as an input or an output in operation of the electrical circuit shown in FIG. 8. The passive infrared (PIR) sensor 51 detects the presence of an infrared-emitting body and provides an input to the PIR processor 52. A pin 65 of the PIR sensor 51 provides a differential-mode signal from the PIR sensor 51 to the PIR processor 52. Resistors R1 and R2 program the PIR processor 52 for sensitivity and responsiveness. Triggering conditions are completely related to internal algorithms of the PIR processor 52, but generally depend on relationships between the strength and timing of the signal at 66 of the PIR sensor 51. objects of a sufficient size are acted upon. Once the processor 52 has decided that the differential input from the passive infrared sensor 51 is indicating a target, signals are from the processor 56 to an aiming light LED 53 which then emits if the aiming light switch 49 is switched on. This function is useful for testing and setup wherein a user may position the game camera 1, turn appropriate switches to the on position and then walk in front of the camera. Upon sensing the infrared emissions of the person, the sensor 51 activates, signals the aiming light 53 to emit a beam of light demonstrating line of view and initiate triggering of the camera 20. From the PIR processor 52, a signal also goes to a camera timing control processor 67. Processor 67 cooperates with PIR processor 52 to trigger the camera 20 with camera inputs passing through transistor Q2 at 68.

The passive infrared sensor 51 is composed of two sensors, one of which receives infrared from the target and the other of which is blind to infrared. The processor 56 determines a difference between the blind sensor and the active sensor so any background noise comprises common mode to both signals and is ignored. Other inputs to the processor 67 are through a switch block 45 including the daytime on/off (morning enable) switch 46, the night on/off (evening enable) switch 47, and the delay switch, which selects either a ten minute delay or routes control from the switch to the potentiometer 43, which is variable between fifteen seconds and a thirty minute delay. If the potentiometer delay is enabled at 48, the potentiometer R15 at 70 is enabled. If the delay at 48 is grounded, the system processor 67 determines that the input is in fixed delay mode. If the input is not grounded, then the processor uses a timing circuit composed of resistor R14, resistor R15 and capacitor C12, the resistors R14 and R15 identified as numeral 70 and the capacitor C12 at 71. The processor 67 discharges the capacitor C12 at 71 and then waits for the capacitor to recharge. The length of time it takes capacitor C12 at 71 to charge provides an indication to the processor 67 of the relative value resistor R15 (the potentiometer) is set to and hence, what relative time delay to use.

The inputs from the morning and evening enable switches 46 and 47 input to the processor 67 at GP5 and GP4, respectively. Behind the aperture 27 is the daylight sensor 73, FIG. 8, which provides light level signals to pin 4 of the processor 67 which are indicative of daylight conditions. Resistors R11, R12 and R13 (if used) connected to the morning, evening and delay switch lines, respectively joining switches 46 and 47 to the processor 67, are pull-ups for the switches and pull the signal to logic-high if the switches 46 and 47 are open, or allow the signal to fall to logic-low if the switches 46 and 47 are closed. A triggering signal is sent via pin 6 from the processor 67 through resistor R16 at 75 and then through transistor Q2 at 68. Diodes D2 and D3 at 76 provide circuit isolation for the camera 20.

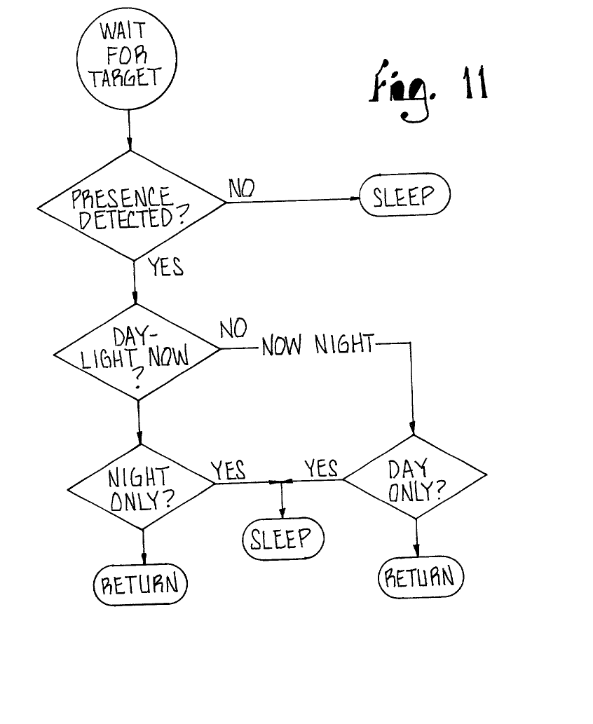

FIG. 9 is a software logic flow diagram of the main control logic which is programmed into the system processor 67. The program runs from “initialize” down to a run loop and does not terminate until the battery is removed or becomes discharged. The software acts upon a signal input from the sensor 51 or any other signal change conditions from any of the input pins. The software determines whether the input signal is a wake-up, a time-out, a changed condition, a pin change or any of the other inputs for the microprocessors having changed state. Upon a change of state, the system processor 67 activates. If there is no input from any of the processor pins, the system processor 67 falls into a nearly no current sleep mode and then wakes up only when a time-out occurs or if a long enough time passes with no inputs. The software causes the system processor 67 to wake up just long enough to confirm that there are no changed conditions. Otherwise, the software keeps the system processor 67 not running, which occurs approximately ninety-eight percent of its lifetime. After initialization and the software parsing for current conditions, the software causes the system processor 67 to wait in target mode, in which it will await a target signal. If there is a target signal and all of the conditions, such as daylight or not daylight and delay are adequate, the system processor 67 triggers the camera 20 and then goes into a wait period again. The waiting is for a fixed delay time or a time delay based upon the potentiometer setting. Then, the software reinitiates and waits for another target. Thus, FIG. 9 is a loop program which will loop as long as there is sufficient battery current, generally down to 4.75 volts. Operation may be unreliable when battery voltage drops into or below this region.

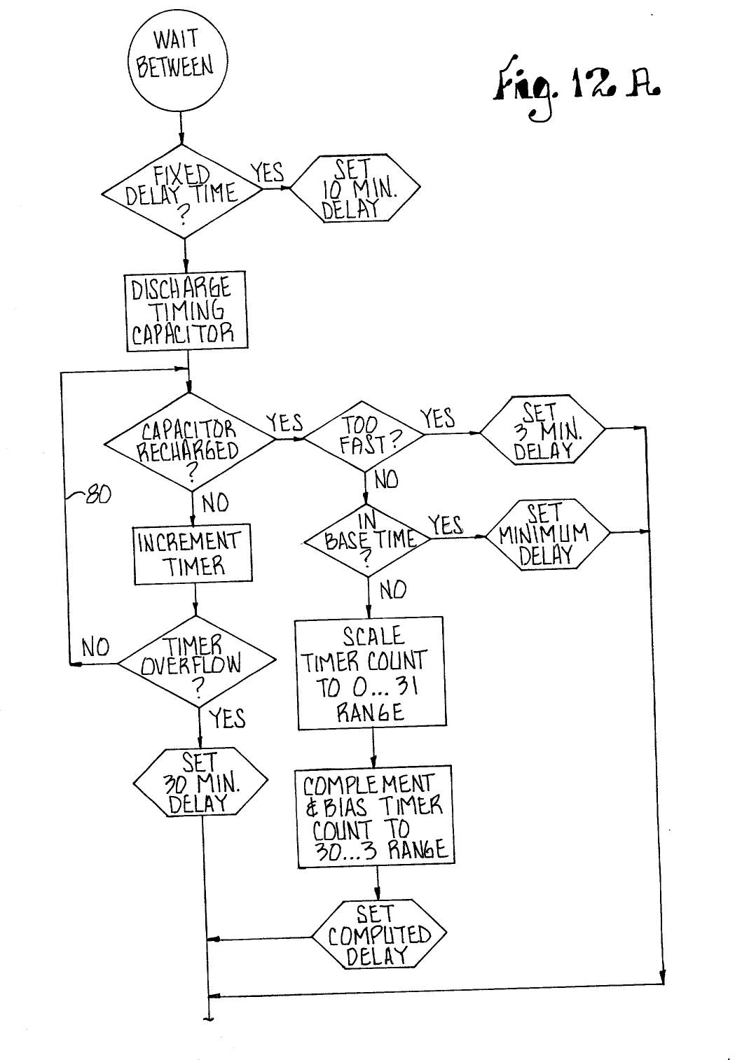

FIG. 10 is another software flow chart documenting the software logic upon taking a picture. After enabling the camera trigger, there is a six second delay to enable the flash to charge again before it can fire. After the delay (by which time the picture will have been taken), the camera trigger is again disabled and the program execution returns to the main loop on FIG. 9.

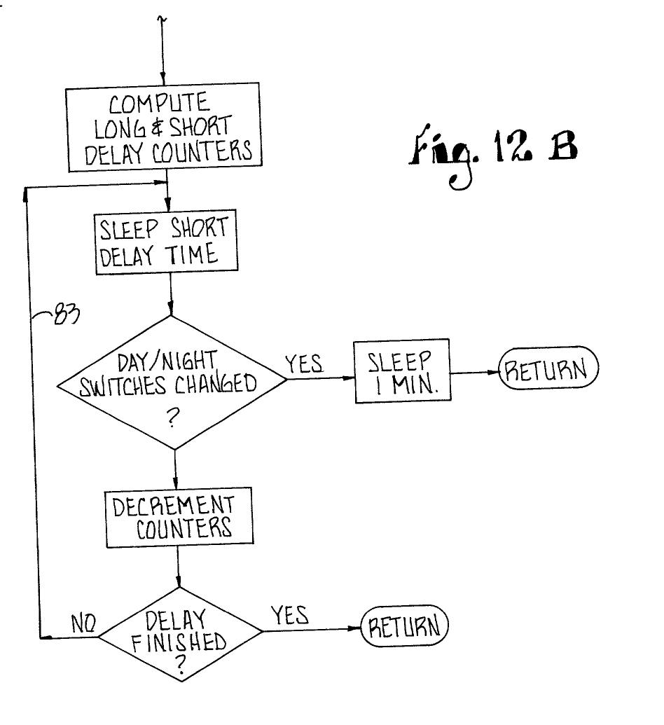

FIG. 11 is a software logic flow diagram for a wait for target mode. If no target presence is detected, the PIR processor 52 remains in a sleep mode where it is simply waiting for a time-out or a change and consuming substantially no battery power. If a target presence is detected, then the software checks whether it is daylight or night and whether day only or night only is enabled. If it is daylight and night only is enabled, then the processor goes back to a sleep mode and vice versa. If the logic returns from wait for target, the flow will go immediately to take pics, FIG. 10. In FIG. 11, arrival at “return” means to take a picture. “Sleep” means that the program will cause the system processor 67 to wait for something to happen, again in the ultra-low power sleep mode.

FIG. 12A shows an upper logic loop at 80 which constitutes a procedure for determining a wait period based upon the settings of the delay switch 48 and the timer potentiometer 43. In an alternative embodiment of the invention, the manufacturer may provide the circuit board with resistor R13 only or resistors R14, R15 and capacitor C12 at 70 and 71, FIG. 8, and the software can determine how the circuit board is equipped. An input to the system processor 67 enables the software to determine whether or not there is a fixed delay time by determining whether the switch 48 is on and the circuit is grounded or if the resistor R13 is present and there is no capacitor C12 there, so there is no charge-up time. The software attempts to signal the timing line from pin 5 and if it finds the timing line is pulled high or pulled low, it provides either a three minute or ten minute fixed delay. If the software attempts to pull the signal low and it fails to immediately come back high, then the software logic loop 80 runs while timing how long it takes for the signal to come back high, indicating a recharged capacitor. If the capacitor C12 takes too long to recharge, indicating a fault in the charging circuit, the software sets a thirty minute delay and defaults to thirty minutes. If the capacitor C12 returns high, the program checks to determine if the capacitor charged too fast, indicating another fault and the software sets a three minute delay. If the capacitor C12 did not charge too fast, then the software determines where in the range of possible delays the delay signal most likely is and develops an index that represents from immediate to very long, which tells it roughly the setting of the potentiometer C12 at 71. The software uses the delay index computed by any of the methods or any of the fail-safes present in the program, the fixed configuration or the potentiometer reading. The delay index is used to compute counters based upon the speed of the system microprocessor 67 and then the software times while the counters time out and permit the time between pictures to run, loop 83, FIG. 12B. There is an escape from the bottom loop 83 so that if the day/night switches are changed, it indicates that the program is actually in a test mode so the program causes the system processor 67 to sleep one minute and return to let matters stabilize and then take another photograph. The whole purpose of the software shown in FIG. 12 is to determine how long to wait and then cause the wait.

The software described in FIGS. 9 through 12, in combination with only one pin of input to the microprocessor 67, computes a relative time based upon a plurality of different configurations without having to change anything in the software. This software enables very low power consumption of the system processor 67 during a waiting state, down to 12 ua (micro-amperes).

The invention afore described provides a very low power consumption for long battery life with a small size for the electronic circuit. This permits a small size overall of the game camera. With the selected microprocessor, the control algorithms may be modified as necessary without substantial change to the support circuitry.

While certain forms of the present invention have been described and illustrated herein, it is not to be limited thereto except insofar as such limitations are included in the following claims.

What is claimed and desired to be secured by Letters Patent is:

1. A surveillance camera comprising:
a) a camera having automatic flash, focus, aperture and shutter speed and film advance functions;
b) a housing for said camera adapted for outdoor installation and protection from adverse weather conditions including intense sun, cold and precipitation;
c) an electronic camera control circuit mounted within said housing and connected to said camera, said control circuit including a programmable microprocessor.

2. The surveillance camera set forth in claim 1 wherein said programmable microprocessor has an interval set function to control the interval between automatically taking photographs.

3. The surveillance camera set forth in claim 2 wherein said interval varies between fifteen seconds and thirty minutes.

4. The surveillance camera set forth in claim 1 wherein said camera includes a day/night enable function.

5. The surveillance camera set forth in claim 1 wherein said camera includes a camera aiming light.

6. A surveillance camera comprising:
a) a camera having automatic flash, auto focus, and automatic film advance functions;
b) said camera mounted within a weather protective housing for outdoor use situated along an area frequented by game animals;
c) an electronic control circuit mounted within said housing and connected to said camera, said control circuit being powered by a battery located within said housing and providing the following functions:
i) a camera aiming light;
ii) a photograph interval variable control;
iii) a day/night enable function; and
iv) a passive infrared monitoring function to discern the presence of a game animal;
d) said control circuit including a microprocessor controlling said circuit to use extremely low battery power during a sleep mode, and then waking said circuit upon a change in condition in any of said functions.

7. The surveillance camera set forth in claim 6 wherein said photograph interval variable control includes a potentiometer variable between approximately 15 seconds and approximately 30 minutes delay.

8. The surveillance camera set forth in claim 6 wherein said flash enable/disable function permits setting said camera for daylight or nighttime use.

9. The surveillance camera set forth in claim 6 wherein when said camera aiming light function is set “on”, a light beam is projected from said surveillance camera when said passive infrared monitoring function detects the presence of an infrared-emitting object within its field of view.

10. The surveillance camera set forth in claim 6 wherein said electronic control circuit controlling said passive infrared monitoring function includes an infrared sensor and a blind sensor and a differential circuit connecting said sensors to said microprocessor whereby an infrared signal of a threshold intensity must be sensed to trigger a take photograph signal.
